(19) United States
(12) Patent Application Publication
(10) Pub. No.: US 2003/0058486 A1
(43) Pub. Date: Mar. 27, 2003

(54) Image communication device and image communication method

(75) Inventors: Fuminobu Ogawa, Tokyo (JP); Shinichi Kuroda, Tokyo (JP); Kazuo Sugimoto, Tokyo (JP); Kohtaro Asai, Tokyo (JP); Yoshihisa Yamada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 09/963,474

(22) Filed: Sep. 27, 2001

(51) Int. Cl. H04N 1/00; H04N 1/04

(52) U.S. Cl. 358/479; 358/405

(57) ABSTRACT

When an electric power is supplied to an image communication device of a user to perform telephone communication between the user and a person on the other end of the communication line, an on-off switch is automatically set to an off state on user's side under control of a video mute control unit so as to disconnect a video data coding/decoding unit from a video data receiving unit. Therefore, no video data received in the video data receiving unit is transmitted from the user to the other end of the communication line. Thereafter, when the user inputs a video mute-off instruction, an on-off switch is set to an on state under control of the video mute control unit so as to connect the video data coding/decoding unit and the video data receiving unit. Therefore, video data received in the video data receiving unit is transmitted from the user to the other end of the communication line. Accordingly, radio communication or wire communication can be performed without troublesome operations or the careless sending of a picture photographing the user to the other end of the communication line.

### BACKGROUND OF THE INVENTION

1. Field of the Invention

The present invention relates to an image communication device and an image communication method in which an image received in a video receiving unit such as a charge-coupled device (CCD) camera is transmitted from a user to a person on the other end through a wire communication line or a radio communication line, and more particularly to an image communication device such as a visual telephone or a picture-phone meeting system and an image communication method in which an image is transmitted through a mobile communication network or a wire communication network.

2. Description of Related Art

FIG. 7 is a block diagram showing the configuration of a conventional image communication device disclosed in Published Unexamined Japanese Patent Application No. H6-233289 of 1994. In FIG. 7, 1 indicates an audio data receiving and outputting unit for receiving audio data on user's side and outputting audio data transmitted from the other end of a communication line. 2 indicates an audio data coding/decoding unit for coding the audio data sent from the audio data receiving and outputting unit 1 and decoding coded audio data transmitted from the other end. 3 indicates a video data receiving unit for receiving video data of user's side. 5 indicates a video data coding/decoding unit for coding the video data sent from the video data receiving unit 3 and decoding coded video data transmitted from the other end. 4 indicates an on-off switch for connecting the video data receiving unit 3 and the video data coding/decoding unit 5 in an on state and disconnecting the video data receiving unit 3 from the video data coding/decoding unit 5 on an off state. 6 indicates a video data outputting unit for outputting video data decoded in the video data coding/decoding unit 5. 8 indicates a video mute instruction outputting unit for outputting a video mute instruction indicating the prohibition of the transmission of the video data according to user's intention. 7 indicates a system control unit for controlling all constituent elements of the image communication device and controlling the on-off switch 4 according to the video mute instruction output from the video mute instruction outputting unit 8. 9 indicates a media data multiplexing and demultiplexing unit for multiplexing the video data coded in the video data coding/decoding unit 5 and the audio data coded in the audio data coding/decoding unit 2 to produce multiplexed media data of user's side and demultiplexing multiplexed media data transmitted from the other end to coded video data and coded audio data. 10 indicates a network interface for transmitting the multiplexed media data produced in the media data multiplexing and demultiplexing unit 9 to the other end through the communication line and receiving the multiplexed media data transmitted from the other end though the communication line.

Next, an operation of the conventional image communication device will be described below.

An operation for sending data from user's side to the other end of the communication line is initially described.

Audio data received in the audio data receiving and outputting unit 1 is coded in the audio data coding/decoding unit 2 and is sent to the media data multiplexing and demultiplexing unit 9. Also, in cases where no video mute instruction is output from the video mute instruction outputting unit 8, the video data receiving unit 3 is connected with the video data coding/decoding unit 5. Therefore, video data received in the video data receiving unit 3 is coded in the video data coding/decoding unit 5 and is sent to the media data multiplexing and demultiplexing unit 9. In the media data multiplexing and demultiplexing unit 9, the coded audio data and the coded video data are multiplexed with each other, and multiplexed media data is transmitted to the other end of the communication line through the communication line and the network interface 10.

Also, in cases where a video mute instruction is output from the video mute instruction outputting unit 8 to the system control unit 7 according to user's intention, the on-off switch 4 is set to an off state by the system control unit 7 to disconnect the video data receiving unit 3 from the video data coding/decoding unit 5, and no video data of user's side is sent to the video data coding/decoding unit 5. That is, no coded video data of user's side is transmitted to the other end through the communication line and the network interface 10. Therefore, even though video data of user's side is received in the video data receiving unit 3, the video data is not transmitted to the person on the other end of the communication line.

Next, an operation for receiving data sent from the person on the other end of the communication line to the user is described.

Multiplexed media data received in the network interface 10 is demultiplexed to coded video data and coded audio data in the media data multiplexing and demultiplexing unit 9. The coded audio data is decoded to audio data in the audio data coding/decoding unit 2, and the audio data is reproduced in the audio data receiving and outputting unit 1. Also, the coded video data is decoded to video data in the video data coding/decoding unit 5, and the video data is displayed as a picture in the video data outputting unit 6.

In general, in cases where image communication is performed between a user and a person on the other end of the communication line, two-directional communication is performed. Therefore, not only a picture photographing the person of the other end is displayed on user's side, but also a picture photographing the user is sent to the other end of the communication line. In cases where the conventional image communication device is arranged for private use, the conventional image communication device of the user is not always set in a condition for sending a picture photographing the user. Also, even though the conventional image communication device of the user is set in a condition for sending a picture photographing the user, there is a probability that the user desires not to send a picture photographing the user to the other end of the communication line. Therefore, it is determined according to user's intention whether or not a picture photographing the user is sent to the other end of the communication line by controlling the on-off switch 4.

However, it is required that the user often determines the outputting of the video mute instruction according to conditions of the user, and a problem has arisen that the operation for often outputting the video mute instruction is troublesome for the user. Also, in cases where the video mute instruction is not output due to the erroneous judgment of the user, a problem has arisen that a picture photographing the user is carelessly transmitted to the other end of the communication line against the user's intention.

### SUMMARY OF THE INVENTION

An object of the present invention is to provide, with due consideration to the drawbacks of the conventional image communication device, an image communication device and an image communication method in which radio communication or wire communication is performed between a user and a person on the other end of a communication line without troublesome operations or the careless sending of user's picture such as a picture photographing the user to the other end of the communication line.

The object is achieved by the provision of an image communication device comprising image receiving means for receiving an image, image mute control means for automatically judging whether or not the image received by the image receiving means is output, and image outputting means for outputting the image received by the image receiving means through a wire communication line or a radio communication line in cases where the image mute control means judges to output the image.

Also, the object is achieved by the provision of an image communication method comprising the steps of receiving an image, automatically judging whether or not the received image is output, and outputting the received image through a wire communication line or a radio communication line in cases where it is judged to output the received image.

Because the outputting of the received image is automatically judged, radio communication or wire communication can be performed between a user and a person on the other end of the communication line without troublesome operations or the careless sending of a picture of user's side such as a picture photographing the user to the other end of the communication line.

It is preferred that the image mute control means controls the image outputting means not to output the image received by the image receiving means when a power is supplied to the image communication device, and the image mute control means controls the image outputting means according to a mute-off instruction to output the image received by the image receiving means.

Therefore, it is prevented that a picture photographing the user is carelessly transmitted to the other end of the communication line when a power is supplied to the image communication device.

It is preferred that the image communication device further comprises time managing means for managing a passing time. The image mute control means judges according to the passing time managed by the time managing means whether or not the image received by the image receiving means is output.

Therefore, in cases where a user desires not to send a picture photographing the user to a person on the other end of the communication line during the night or holiday, the image communication device can be automatically set in a video mute-on state during the night or holiday.

It is preferred that the image communication device further comprises an electronic phone book for setting a mute-off state for each of other some ends of communication, wherein the image mute control means judges that the image received by the image receiving means is output to one end of communication in cases where the mute-off state is set for the end by the electronic phone book, and the image mute control means judges that the image received by the image receiving means is not output to one end of communication in cases where no mute-off state is set for the end by the electronic phone book.

Therefore, even though a phone call is received from either an unknown person not listed in the electronic phone book or a non-intimate person listed in the electronic phone book, it is prevented that a received picture such as a picture photographing a user is carelessly transmitted to the unknown person or the non-intimate person.

It is preferred that the image communication device further comprises error monitoring means for monitoring a degree of error occurring in the communication line, wherein the image mute control means judges according to the degree of error monitored by the error monitoring means whether or not the image received by the image receiving means is output.

Therefore, in cases where the degree of error is high so as to distort a transmitted picture during the telephone communication, a received picture is not transmitted from the image communication device of user's end to the other end.

It is preferred that the image communication device further comprises image storing means for storing an image in advance. The image stored by the image storing means is output by the image outputting means in cases where the image mute control means judges to output the image stored by the image storing means in place of the image received by the image receiving means.

Therefore, in cases where the user desires not to transmit a picture photographing the user to the other end, another picture can be transmitted to the other end. Accordingly, even though a picture photographing the user is not transmitted to the other end, an unfavorable impression on the user made by the other end can be reduced.

### BRIEF DESCRIPTION OF THE DRAWINGS

FIG. 1 is a block diagram showing the configuration of an image communication device according to a first embodiment of the present invention;

FIG. 2 is a block diagram showing the configuration of an image communication device according to a second embodiment of the present invention;

FIG. 3 is a block diagram showing the configuration of an image communication device according to a third embodiment of the present invention;

FIG. 4 shows an example of attribute information held and managed in an electronic phone book of the image communication device shown in FIG. 3;

FIG. 5 is a block diagram showing the configuration of an image communication device according to a fourth embodiment of the present invention;

FIG. 6 is a block diagram showing the configuration of an image communication device according to a fifth embodiment of the present invention; and

FIG. 7 is a block diagram showing the configuration of a conventional image communication device.

### DETAILED DESCRIPTION OF THE PREFERRED EMBODIMENTS

Embodiments of the present invention will now be described with reference to the accompanying drawings.

Embodiment 1

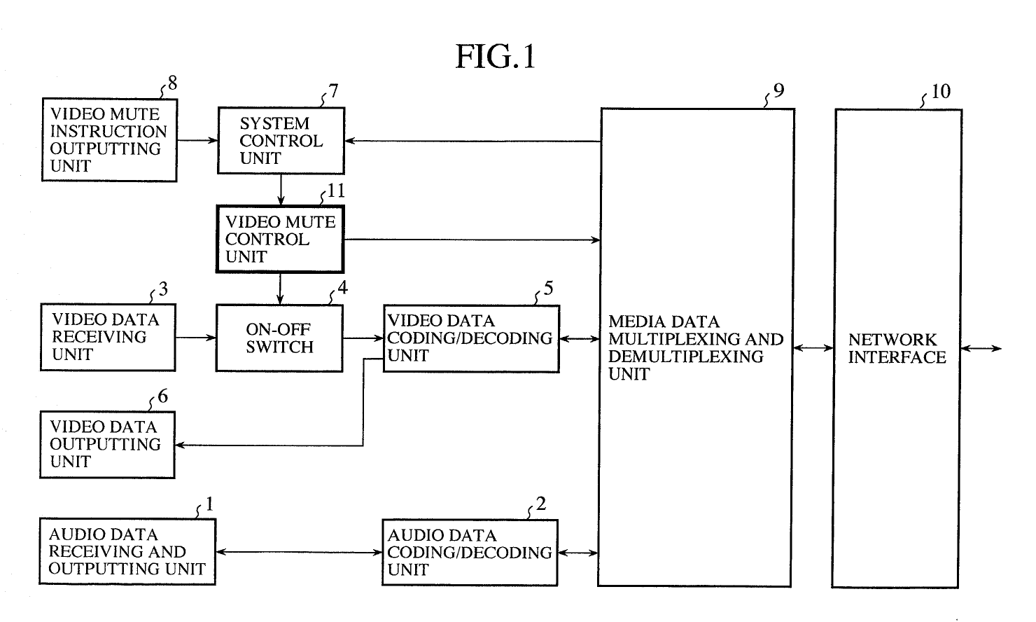

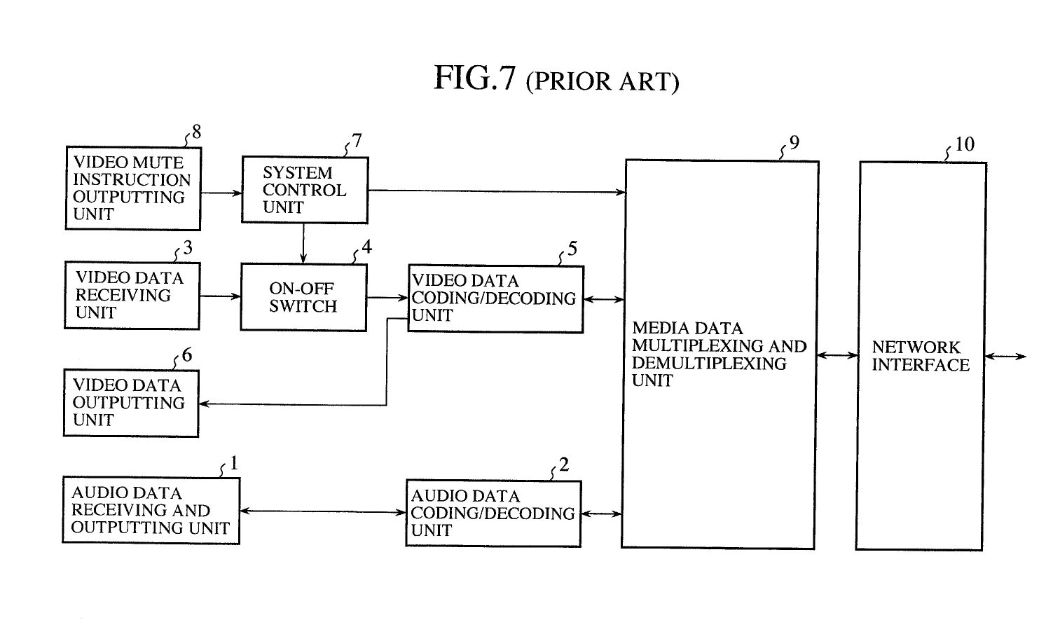

FIG. 1 is a block diagram showing the configuration of an image communication device according to a first embodiment of the present invention. The constituent elements, which are the same as those shown in FIG. 7, are indicated by the same reference numerals as those of the constituent elements shown in FIG. 7, and additional description of those constituent elements is omitted.

In FIG. 1, 11 indicates a video mute control unit for producing video mute on/off information indicating the setting of a video mute-on state or the setting of a video mute-off state according to the existence of the video mute instruction output from the video mute instruction outputting unit 8 and outputting the video mute on/off information to a person on the other end of the communication line to make the person recognize the video mute-on state or the video mute-off state set on user's side.

The video data receiving unit 3 functions as an image receiving means, the video mute control unit 11 functions as an image mute control means, and the media data multiplexing and demultiplexing unit 9 and the network interface 10 function as an image outputting means.

Next, an operation of the image communication device will be described below.

An operation for sending data from user's side to the other end of the communication line is initially described.

When the supply of an electric power to the image communication device is started on user's side, the video mute control unit 11 automatically sets the image communication device to a video mute-on state. That is, the video mute control unit 11 produces video mute on/off information indicating the setting of the video mute-on state, and the video mute on/off information is sent to the media data multiplexing and demultiplexing unit 9. Also, the video data receiving unit 3 is disconnected from the video data coding/decoding unit 5 by setting the on-off switch 4 to an off state under the control of the video mute control unit 11. Therefore, video data received in the video data receiving unit 3 is not sent to the video data coding/decoding unit 5. That is, no coded video data is sent to the media data multiplexing and demultiplexing unit 9. Also, audio data received in the audio data receiving and outputting unit 1 is coded in the audio data coding/decoding unit 2 and is sent to the media data multiplexing and demultiplexing unit 9. In the media data multiplexing and demultiplexing unit 9, the video mute on/off information produced in the video mute control unit 11 and the coded audio data are multiplexed with each other to produce multiplexed media data, and the multiplexed media data is sent to a person on the other end of the communication line through the network interface 10 and the communication line. On the other end of the communication line, the multiplexed media data is demultiplexed to the coded audio data and the video mute on/off information in the media data multiplexing and demultiplexing unit 9, and the coded audio data is decoded and reproduced. Also, the video mute on/off information is analyzed in the system control unit 7, and it is recognized on the other end of the communication line that the video mute-on state is set on user's side. Therefore, no operation of the decoding of coded video data is performed on the other end of the communication line.

Here, the video mute-on state set in the image communication device is automatically maintained until a video mute-off instruction is output from the video mute instruction outputting unit 8 to the system control unit 7 according to user's intention.

Thereafter, when the user operates the video mute instruction outputting unit 8 so as to output a video mute-off instruction from the video mute instruction outputting unit 8, the video mute-off instruction is sent to the system control unit 7. The system control unit 7 controls all constituent elements of the image communication device and controls the video mute control unit 11 according to the video mute-off instruction. Therefore, the image communication device is set in a video mute-off state under the control of the video mute control unit 11. That is, the video mute control unit 11 produces video mute on/off information indicating the setting of the video mute-off state according to the video mute-off instruction, and the video mute on/off information is sent to the media data multiplexing and demultiplexing unit 9. Also, the video data receiving unit 3 is connected with the video data coding/decoding unit 5 by setting the on-off switch 4 to an on state under the control of the video mute control unit 11, and video data received in the video data receiving unit 3 is coded in the video data coding/decoding unit 5 and is sent to the media data multiplexing and demultiplexing unit 9. Also, audio data received in the audio data receiving and outputting unit I is coded in the audio data coding/decoding unit 2 and is sent to the media data multiplexing and demultiplexing unit 9. In the media data multiplexing and demultiplexing unit 9, the video mute on/off information produced in the video mute control unit 11, the coded audio data and the coded video data are multiplexed with each other to produce multiplexed media data, and the multiplexed media data is sent to a person of the other end of the communication line through the network interface 10 and the communication line. On the other end of the communication line, the multiplexed media data is demultiplexed to the coded audio data, the coded video data and the video mute on/off information in the media data multiplexing and demultiplexing unit 9, the coded audio data is decoded and reproduced, the video mute on/off information is analyzed in the system control unit 7, and it is recognized on the other end of the communication line that a video mute-off state is set on user's side. Therefore, the coded video data is decoded in the video data coding/decoding unit 5 and is output from the video data outputting unit 6 as a picture.

Therefore, when the operation of the image communication device is started, the image communication device is automatically set to a video mute-on state under the control of the video mute control unit 11. That is, even though a picture of user's side such as a picture photographing the user is received in the video receiving unit 3, the picture of user's side is not transmitted to the person on the other end of the communication line until the user operates the video mute instruction outputting unit 8. Also, in cases where the user operates the video mute instruction outputting unit 8 to output a video mute-off instruction from the video mute instruction outputting unit 8, the image communication device is automatically set to a video mute-off state under the control of the video mute control unit 11. That is, a picture of user's side received in the video receiving unit 3 is transmitted to the other end of the communication line until the user operates the video mute instruction outputting unit 8 so as to set the image communication device to a video mute-on state.

Also, the video mute on/off information is transmitted to the other end of the communication line and is analyzed in the system control unit 7 of other end of the communication line, and it is recognized on the other end of the communication line whether or not coded video data is transmitted from the user's side to the other end of the communication line. Therefore, in cases where it is recognized on the other end of the communication line that no coded video data is transmitted from the user's side to the other end of the communication line, no operation of receiving coded video data is performed on the other end of the communication line or an operation of displaying a picture of the other end of the communication line is performed on the other end of the communication line. As a result, an operation speed on the other end of the communication line is heightened, and a degree of freedom for the operation is improved on the other end of the communication line.

As is described above, in the first embodiment, because the image communication device is automatically set to a video mute-on state when the supply of an electric power to the image communication device is started, the user is not required to manually set the image communication device to a video mute-on state. Therefore, the troublesomeness in the setting of the image communication device to a video mute-on state can be reduced.

Also, in the first embodiment, the image communication device is set to a video mute-off state when the user intentionally operates the video mute instruction outputting unit 8. Therefore, it is prevented that a picture of user's side such as a picture photographing the user is erroneously sent to the person on the other end of the communication line against user's intention.

Also, in the first embodiment, video mute on/off information indicating the setting of a video mute-on state or the setting of a video mute-off state is produced in the video mute control unit 11 and is transmitted to the other end of the communication line. Therefore, it can be recognized on the other end of the communication line that no coded video data is sent from user's side to the other end of the communication line, and an operation speed on the other end of the communication line can be heightened.

In the first embodiment, the video data receiving unit 3, the video data outputting unit 6 and the video mute instruction outputting unit 8 are arranged in the image communication device. However, the first embodiment is not limited to this arrangement. For example, it is applicable that the video data receiving unit 3, the video data outputting unit 6 and the video mute instruction outputting unit 8 arranged outside of the image communication device be connected with the image communication device.

Also, in the first embodiment, video data of a moving picture is processed in the video data receiving unit 3, the video data outputting unit 6 and the video mute control unit 11. However, the first embodiment is not limited to the video data of the moving picture. For example, it is applicable that data of a still picture be processed in the video data receiving unit 3, the video data outputting unit 6 and the video mute control unit 11. In this case, the image communication device is set to a mute-off state or a mute-on state under the control of the system control unit 7.

Also, in the first embodiment, the on-off switch 4 is arranged between the video data receiving unit 3 and the video data coding/decoding unit 5, and a video mute operation is performed by setting the on-off switch 4 to an on state or an off state. However, it is applicable that the on-off switch 4 be arranged between the video data coding/decoding unit 5 and the media data multiplexing and demultiplexing unit 9 to control the inputting of the coded video data to the media data multiplexing and demultiplexing unit 9 by setting the on-off switch 4 to an on state or an off state.

Embodiment 2

In the first embodiment, when the supply of an electric power to the image communication device is started, the image communication device is automatically set to the video mute-on state. When the user operates the video mute instruction outputting unit 8 so as to output a video mute-off instruction to the system control unit 7, the image communication device is set to the video mute-off state. In contrast, in a second embodiment, the image communication device is automatically set to the video mute-on state at a predetermined time of day, and the image communication device is automatically set to the video mute-off state at another predetermined time of day.

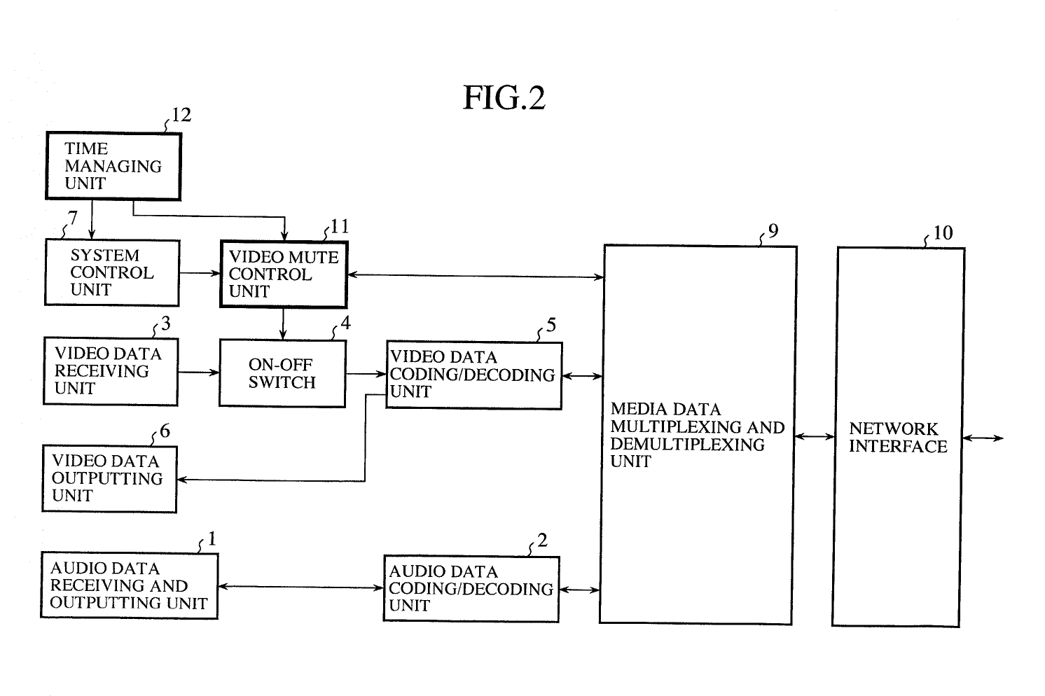

FIG. 2 is a block diagram showing the configuration of an image communication device according to a second embodiment of the present invention. The constituent elements, which are the same as those shown in FIG. 1, are indicated by the same reference numerals as those of the constituent elements shown in FIG. 1, and additional description of those constituent elements is omitted. In FIG. 2, 12 indicates a time managing unit for counting a current time (or a passing time) of day to manage the current time as time information. The video mute instruction outputting unit 8 is not arranged in the image communication device.

Next, an operation of the image communication device will be described below.

In the system control unit 7, a mute-on time of day is set in advance for the purpose of automatically setting the image communication device to a video mute-on state at the mute-on time of day, and a mute-off time of day is set in advance for the purpose of automatically setting the image communication device to a video mute-off state at the mute-off time of day.

Thereafter, a current time of day counted in the time managing unit 12 is always detected in the system control unit 7, and it is checked in the system control unit 7 whether or not the current time of day agrees with the mute-on time of day or the mute-off time of day. Also, audio data received in the audio data receiving and outputting unit 1 is always coded in the audio data coding/decoding unit 2 and is sent to the media data multiplexing and demultiplexing unit 9.

In cases where the current time of day agrees with the mute-on time of day, the image communication device is automatically set to a video mute-on state under the control of the system control unit 7. That is, the system control unit 7 controls the video mute control unit 11 to produce video mute on/off information indicating the setting of the video mute-on state. The video mute on/off information is sent to the media data multiplexing and demultiplexing unit 9. Also, the video data receiving unit 3 is disconnected from the video data coding/decoding unit 5 by setting the on-off switch 4 to an off state under the control of the video mute control unit 11. In this case, video data received in the video data receiving unit 3 is not sent to the video data coding/decoding unit 5. That is, no coded video data is sent to the media data multiplexing and demultiplexing unit 9. In the media data multiplexing and demultiplexing unit 9, the video mute on/off information produced in the video mute control unit 11 and the coded audio data are multiplexed with each other, and multiplexed media data is transmitted to a person on the other end of the communication line through the network interface 10 and the communication line. Therefore, the multiplexed media data is processed on the other end of the communication line in the same manner as in the first embodiment.

Also, in cases where the current time of day agrees with the mute-off time of day, the image communication device is automatically set to a video mute-off state under the control of the system control unit 7. That is, the system control unit 7 controls the video mute control unit 11 to produce video mute on/off information indicating the setting of the video mute-off state. The video mute on/off information is sent to the media data multiplexing and demultiplexing unit 9. Also, the video data receiving unit 3 is connected with the video data coding/decoding unit 5 by setting the on-off switch 4 to an on state under the control of the video mute control unit 11. In this case, video data received in the video data receiving unit 3 is coded in the video data coding/decoding unit 5 and is sent to the media data multiplexing and demultiplexing unit 9. In the media data multiplexing and demultiplexing unit 9, the video mute on/off information produced in the video mute control unit 11, the coded audio data and the coded video data are multiplexed with each other, and multiplexed media data is transmitted to the other end of the communication line through the network interface 10 and the communication line. Therefore, the multiplexed media data is processed on the other end of the communication line in the same manner as in the first embodiment.

For example, a mute-on time of day is set to twenty-three o'clock, and a mute-off time of day is set to seven o'clock. In this case, the on-off switch 4 is set to an on state at twenty-three o'clock under the control of the video mute control unit 11, and the on-off switch 4 is set to an off state at seven o'clock under the control of the video mute control unit 11. Therefore, the image communication device is set in a video mute-on state in a time period from twenty-three o'clock to seven, and the image communication device is set in a video mute-off state in a time period from seven o'clock to twenty-three.

As is described above, in the second embodiment, a current time of day is counted in the time managing unit 12, and a mute-on time of day and a mute-off time of day are set in advance in the system control unit 7. Therefore, the image communication device can be automatically set in a video mute-on state in a time period from the mute-on time of day to the mute-off time of day, and the image communication device can be automatically set in a video mute-off state in a time period from the mute-off time of day to the mute-on time of day. Accordingly, for example, in cases where a user desires not to send a picture photographing the user to a person on the other end of the communication line during the night or holiday, the image communication device can be automatically set in a video mute-on state during the night or holiday.

In the second embodiment, one mute-on time of day and one mute-off time of day are set. However, it is applicable that a plurality of mute-on times of day and a plurality of mute-off times of day be set. Also, it is applicable that only a mute-on time of day or only a mute-off time of day be set. Also, it is applicable that a mute-on date and a mute-off date be set. For example, a day of the week, a day of the month or a month is set as a mute-on date and a mute-off date.

Embodiment 3

In a third embodiment, the image communication device is automatically set in a video mute-off state in telephone communication with an intimate person listed in an electronic phone book, and the image communication device is automatically set in a video mute-on state in telephone communication with an unknown person not listed in the electronic phone book or a non-intimate person not admitted in the electronic phone book to be set to the video mute-off state.

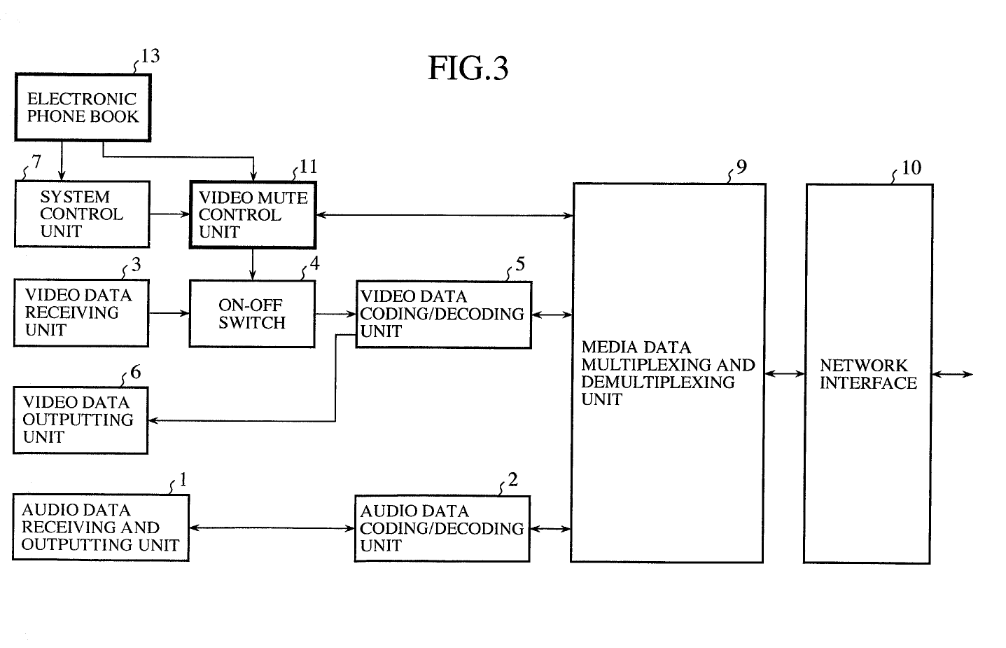

FIG. 3 is a block diagram showing the configuration of an image communication device according to a third embodiment of the present invention. The constituent elements, which are the same as those shown in FIG. 1, are indicated by the same reference numerals as those of the constituent elements shown in FIG. 1, and additional description of those constituent elements is omitted.

In FIG. 3, 13 indicates an electronic phone book for holding and managing a set of name and phone number and a mute mark for each known person on the other end of a communication line. The existence of the mute mark indicates the setting of a mute-off state. The video mute instruction outputting unit 8 is not arranged in the image communication device.

Next, an operation of the image communication device will be described below.

A set of name and phone number is listed in the electronic phone book 13 in advance for each known person on the other end of a communication line. Also, a mute mark is attached to each intimate person in the electronic phone book 13 in advance to admit telephone communication with the intimate person on a mute-off state. The sets of names and phone numbers and the mute marks are written in the electronic phone book 13 by a user by using a ten key keyboard (not shown) or a tool connected with the image communication device.

When a user dials a phone number to call a person on the other end of the communication line, the dialed phone number is detected in the system control unit 7 of the user's side, and the dialed phone number is sent to the video mute control unit 11 of the user's side. Also, when a user receives a phone call from a person of the other end of the communication line, a phone number of the other end of the communication line is detected in the system control unit 7 of user's side, and the detected phone number is sent to the video mute control unit 11 of user's side.

In the video mute control unit 11, it is checked whether or not the phone number (the dialed phone number or the detected phone number) is listed in the electronic phone book 13. In cases where the phone number is listed in the electronic phone book 13, it is checked whether or not a mute mark is attached to the phone number in the electronic phone book 13. In cases where a mute mark is attached to the phone number, the image communication device is automatically set to a video mute-off state under the control of the video mute control unit 11. That is, the video mute control unit 11 produces video mute on/off information indicating the setting of the video mute-off state, and the video mute on/off information is sent to the media data multiplexing and demultiplexing unit 9. Also, the video data receiving unit 3 is connected with the video data coding/decoding unit 5 by setting the on-off switch 4 to an on state under the control of the video mute control unit 11, and video data received in the video data receiving unit 3 is coded in the video data coding/decoding unit 5 and is sent to the media data multiplexing and demultiplexing unit 9. Also, audio data received in the audio data receiving and outputting unit 1 is always coded in the audio data coding/decoding unit 2 and is sent to the media data multiplexing and demultiplexing unit 9. Therefore, multiplexed media data is produced in the media data multiplexing and demultiplexing unit 9 and is transmitted to the other end in the same manner as in the first embodiment.

In contrast, in cases where the phone number is not listed in the electronic phone book 13, or in cases where no mute mark is attached to the phone number even though the phone number is listed in the electronic phone book 13, the image communication device is automatically set to a video mute-on state under the video mute control unit 11. That is, the video mute control unit 11 produces video mute on/off information indicating the setting of the video mute-on state, and the video mute on/off information is sent to the media data multiplexing and demultiplexing unit 9. Also, the video data receiving unit 3 is disconnected from the video data coding/decoding unit 5 by setting the on-off switch 4 to an off state under the control of the video mute control unit 11, and video data received in the video data receiving unit 3 is not sent to the video data coding/decoding unit 5. That is, no coded video data is sent to the media data multiplexing and demultiplexing unit 9. Also, audio data received in the audio data receiving and outputting unit 1 is always coded in the audio data coding/decoding unit 2 and is sent to the media data multiplexing and demultiplexing unit 9. Therefore, multiplexed media data is produced in the media data multiplexing and demultiplexing unit 9 and is transmitted to the other end in the same manner as in the first embodiment.

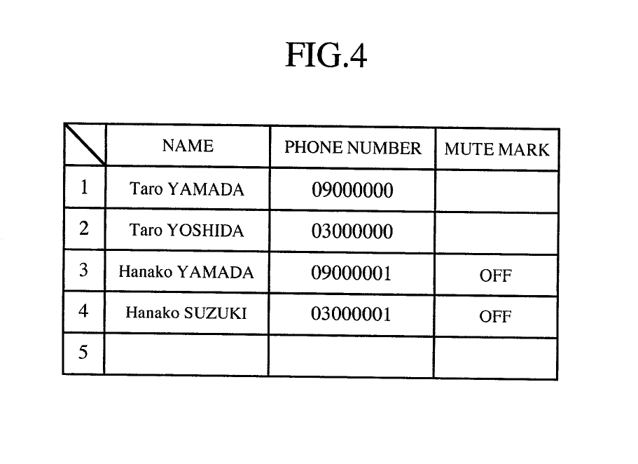

FIG. 4 shows an example of a plurality of sets of attribute information held and managed in the electronic phone book 13.

In this example shown in FIG. 4, a set of name and phone number is listed in the electronic phone book 13 for each registered person. Also, a mute mark is attached to each intimate person, who is admitted to be set to the video mute-off state, as attribute information in the electronic phone book 13.

In detail, a mute mark indicating the setting of a video mute-off state is attached to both the name “Hanako YAMADA” and the name “Hanako SUZUKI”, and no mute mark is attached to the name “Taro YAMADA” or the name “Taro YOSHIDA”.

In cases where a user receives a phone call from Hanako YAMADA, a phone number “09000001” of Hanako YAMADA is detected, it is detected that the phone number “09000001” is listed in the electronic phone book 13, and it is detected that a mute mark is attached to the name “Hanako YAMADA” corresponding to the phone number “09000001”. Therefore, the video data receiving unit 3 is connected with the video data coding/decoding unit 5, and a picture photographing the user is transmitted to the other end of the telephone communication. Also, in cases where a user receives a phone call from a person of a phone number “09000005”, because the phone number “09000005” is not listed in the electronic phone book 13, the video data receiving unit 3 is disconnected from the video data coding/decoding unit 5, and a picture received in the video data receiving unit 3 is not transmitted to the other end of the telephone communication. Also, in cases where a user receives a phone call from Taro YAMADA or Taro YOSHIDA, a phone number “09000000” or “03000000” of Taro YAMADA or Taro YOSHIDA is detected, it is detected that the phone number “09000000” or “03000000” is listed in the electronic phone book 13, and it is detected that a mute mark is not attached to the name “Taro YAMADA” corresponding to the phone number “09000000” or the name “Taro YOSHIDA” corresponding to “03000000”. Therefore, the video data receiving unit 3 is disconnected from the video data coding/decoding unit 5, and a picture received in the video data receiving unit 3 is not transmitted to Taro YAMADA or Taro YOSHIDA.

As is described above, in the third embodiment, a plurality of sets of names, phone numbers and mute marks are held and managed in the electronic phone book 13, and it is checked whether or not a mute mark indicating the setting of a video mute-off state is attached to a person on the other end of the telephone communication. Therefore, even though a phone call is received from either an unknown person not listed in the electronic phone book 13 or a non-intimate person listed in the electronic phone book 13, it is prevented that a picture received in the video data receiving unit 3 such as a picture photographing a user is carelessly transmitted to the unknown person or the non-intimate person.

In the third embodiment, an operation for checking whether or not the dialed phone number or the detected phone number is listed in the electronic phone book 13 is performed in the video mute control unit 11. However, it is applicable that the checking operation be performed in the system control unit 7.

Embodiment 4

In a fourth embodiment, the image communication device is automatically set in a video mute-on state in cases where a ratio of an amount of erred data to an amount of data transmitted from the other end of telephone communication is high, and the image communication device is automatically set in a video mute-off state in cases where the ratio is low.

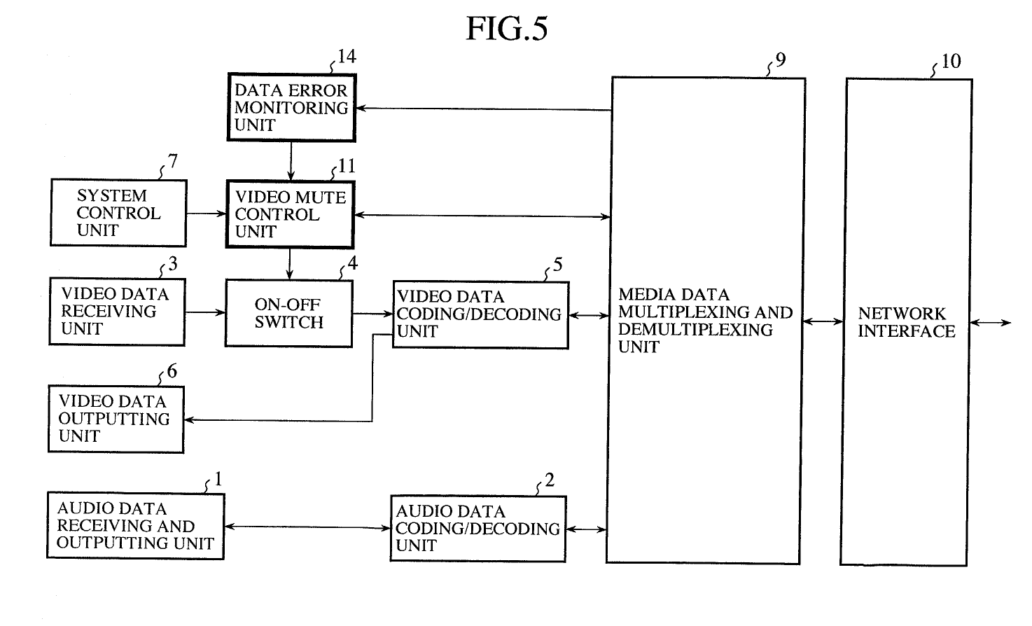

FIG. 5 is a block diagram showing the configuration of an image communication device according to a fourth embodiment of the present invention. The constituent elements, which are the same as those shown in FIG. 1, are indicated by the same reference numerals as those of the constituent elements shown in FIG. 1, and additional description of those constituent elements is omitted.

In FIG. 5, 14 indicates a data error monitoring unit for monitoring data transmitted from the other end of the telephone communication to detect erred data included in the transmitted data, and detecting a ratio of an amount of the erred data to an amount of the transmitted data as a data error rate. The video mute instruction outputting unit 8 is not arranged in the image communication device.

Next, an operation of the image communication device will be described below.

A threshold value of the video mute-on state and a threshold value of the video mute-off state are set in advance in the system control unit 7, and the threshold value of the video mute-on state and the threshold value of the video mute-off state are sent to the video mute control unit 11. Here, the threshold value of the video mute-on state is set to be higher than the threshold value of the video mute-off state. For example, the threshold value of the video mute-on state is set to 10⁻³, and the threshold value of the video mute-off state is set to 10⁻⁴.

During telephone communication between a user and a person on the other end of the communication line, data transmitted from the other end of the communication line is received in the data error monitoring unit 14, erred data included in the transmitted data is detected, and a ratio of an amount of erred data to an amount of the transmitted data is detected as a data error rate. The data error rate detected in the data error monitoring unit 14 is sent to the video mute control unit 11.

In the video mute control unit 11, it is checked whether or not the data error rate is equal to or higher than the threshold value of the video mute-on state, and it is checked whether or not the data error rate is equal to or lower than the threshold value of the video mute-off state. In cases where the data error rate is equal to or higher than the threshold value of the video mute-on state on condition that the image communication device of the user's side is set in a video mute-off state, it is judged that the data error rate is too high to transmit video data from the user's side to the other end of the communication line. Therefore, the image communication device of the user's side is automatically changed from the video mute-off state to a video mute-on state under the control of the video mute control unit 11. That is, the video mute control unit 11 produces video mute on/off information indicating the setting of the video mute-on state, and the video mute on/off information is sent to the media data multiplexing and demultiplexing unit 9. Also, the video data receiving unit 3 is disconnected from the video data coding/decoding unit 5 by setting the on-off switch 4 to an off state under unit 5 and is sent to the media data multiplexing and demultiplexing unit 9. Also, audio data received in the audio data receiving and outputting unit 1 is always coded in the audio data coding/decoding unit 2 and is sent to the media data multiplexing and demultiplexing unit 9. Therefore, multiplexed media data is produced in the media data multiplexing and demultiplexing unit 9 and is transmitted to the other end in the same manner as in the first embodiment.

As is described above, in the fourth embodiment, a data error rate is detected in the data error monitoring unit 14, the data error rate is compared with a threshold value of the video mute-on state and a threshold value of the video mute-off state in the video mute control unit 11, the image communication device is automatically set to a video mute-on state in cases where the data error rate is equal to or higher than the threshold value of the video mute-on state, and the image communication device is automatically set to a video mute-off state under the control of the video mute control unit 11 in cases where the data error rate is equal to or lower than the threshold value of the video mute-off state. Therefore, in cases where the data error rate is high so as to distort a picture transmitted with audio data during the telephone communication, a picture received in the video data receiving unit 3 is not transmitted from the image communication device of the user's side to the other end of the communication line.

In the fourth embodiment, two threshold values are set in advance in the system control unit 7. However, it is the control of the video mute control unit 11. Therefore, video data received in the video data receiving unit 3 is not sent to the video data coding/decoding unit 5. Also, audio data received in the audio data receiving and outputting unit 1 is always coded in the audio data coding/decoding unit 2 and is sent to the media data multiplexing and demultiplexing unit 9. Therefore, multiplexed media data is produced in the media data multiplexing and demultiplexing unit 9 and is transmitted to the other end in the same manner as in the first embodiment.

Also, in cases where the data error rate is equal to or lower than the threshold value of the video mute-off state on condition that the image communication device of the user's side is set in the video mute-on state, it is judged that the data error rate is sufficiently low to transmit video data from the user's side to the other end of the communication line. Therefore, the image communication device of the user's side is automatically changed from the video mute-on state to the video mute-off state under the control of the video mute control unit 11. That is, the video mute control unit 11 produces video mute on/off information indicating the setting of the video mute-off state, and the video mute on/off information is sent to the media data multiplexing and demultiplexing unit 9. Also, the video data receiving unit 3 is connected with the video data coding/decoding unit 5 by setting the on-off switch 4 to an on state under the control of the video mute control unit 11, and video data received in the video data receiving unit 3 is coded in the video data coding/decoding applicable that only one threshold value be set in advance in the system control unit 7. In this case, the image communication device of the user's side is automatically set in the video mute-on state in cases where the data error rate is equal to or higher than the threshold value, and the image communication device of the user's side is automatically set in the video mute-off state in cases where the data error rate is equal to or lower than the threshold value.

Embodiment 5

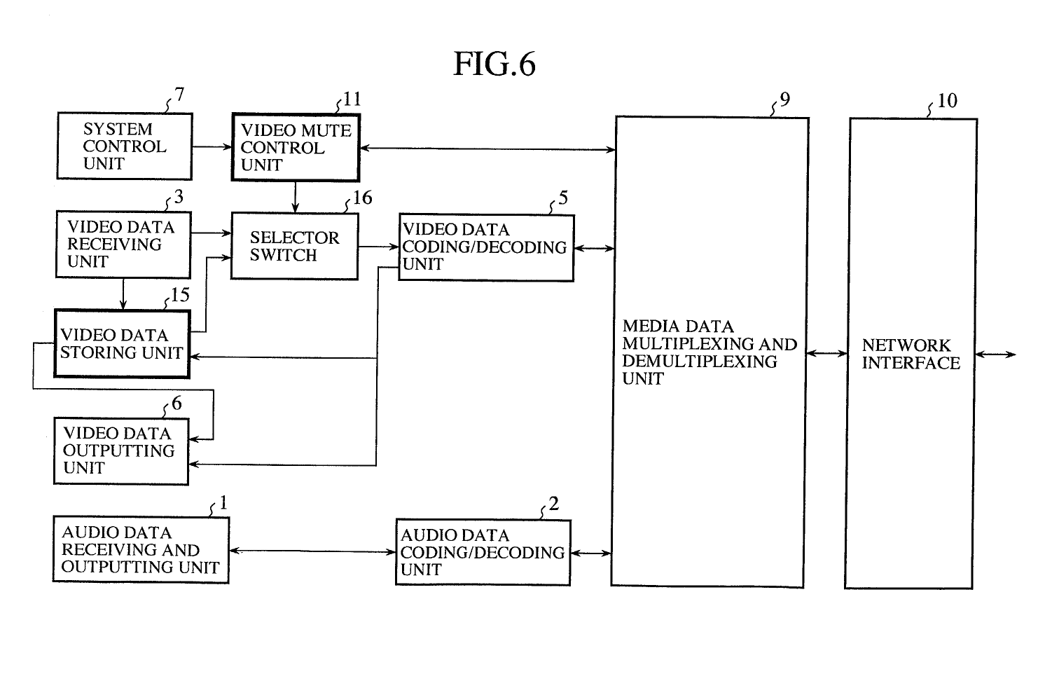

FIG. 6 is a block diagram showing the configuration of an image communication device according to a fifth embodiment of the present invention. The constituent elements, which are the same as those shown in FIG. 1, are indicated by the same reference numerals as those of the constituent elements shown in FIG. 1, and additional description of those constituent elements is omitted.

In FIG. 6, 15 indicates a video data storing unit for storing video data received in the video data receiving unit 3 in advance and storing video data which is transmitted from the other end of the communication line and is decoded in the video data coding/decoding unit 5. It is applicable that video data of a picture produced in either the image communication device or a tool connected with the image communication device be stored in the video data storing unit 15 in place of the video data received in the video data receiving unit 3. 16 indicates a selector switch for selecting the video data receiving unit 3 or the video data storing unit 15 under the control of the video mute control unit 11 to connect the video data coding/decoding unit 5 with either the video data receiving unit 3 or the video data storing unit 15. The selector switch 16 is arranged in place of the on-off switch 4, and the video mute instruction outputting unit 8 is not arranged in the image communication device.

Next, an operation of the image communication device will be described below.

The image communication device is set to a video mute-on state or a video mute-off state according to user's intention under the control of the system control unit 7. In cases where a video mute-off instruction is sent from the system control unit 7 to the video mute control unit 11 according to user's intention, the image communication device is set to a video mute-off state under the control of the video mute control unit 11. In this case, video mute on/off information indicating the setting of the video mute-off state is produced in the video mute control unit 11 according to the video mute-off instruction, and the video mute control unit 11 controls the selector switch 16 to connect the video data receiving unit 3 with the video data coding/decoding unit 5. Thereafter, the video mute on/off information is sent to the media data multiplexing and demultiplexing unit 9, video data received in the video data receiving unit 3 is coded in the video data coding/decoding unit 5 and is sent to the media data multiplexing and demultiplexing unit 9, and audio data received in the audio data receiving and outputting unit 1 is always coded in the audio data coding/decoding unit 2 and is sent to the media data multiplexing and demultiplexing unit 9. Therefore, multiplexed media data is produced in the media data multiplexing and demultiplexing unit 9 and is transmitted to the other end in the same manner as in the first embodiment.

In contrast, in cases where a video mute-on instruction is sent from the system control unit 7 to the video mute control unit 11 according to user's intention, the image communication device is set to a video mute-on state under the control of the video mute control unit 11. In this case, video mute on/off information indicating the setting of the video mute-on state is produced in the video mute control unit 11 according to the video mute-on instruction, and the video mute control unit 11 controls the selector switch 16 to connect the video data storing unit 15 with the video data coding/decoding unit 5. Thereafter, the video mute on/off information is sent to the media data multiplexing and demultiplexing unit 9, video data stored in the video data storing unit 15 is coded in the video data coding/decoding unit 5 and is sent to the media data multiplexing and demultiplexing unit 9, and audio data received in the audio data receiving and outputting unit 1 is always coded in the audio data coding/decoding unit 2 and is sent to the media data multiplexing and demultiplexing unit 9. Therefore, multiplexed media data produced in the media data multiplexing and demultiplexing unit 9 is processed on the other end in the same manner as in the first embodiment.

In the fifth embodiment, the setting of the image communication device to a video mute-on state or a video mute-off state is manually performed according to user's intention. However, the fifth embodiment is not limited to the setting according to user's intention. For example, in the same manner as in the first embodiment, it is applicable that the image communication device be automatically set to the video mute-on state at a time of the supply of an electric power to the image communication device and the image communication device be set to the video mute-off state in response to user's intention. In this case, the video mute instruction outputting unit 8 is additionally arranged in the image communication device. Also, in the same manner as in the second embodiment, it is applicable that the image communication device be automatically set to the video mute-on state at a predetermined time of day and the image communication device be automatically set to the video mute-off state at another predetermined time of day. In this case, the time managing unit 12 is additionally arranged in the image communication device. Also, in the same manner as in the third embodiment, it is applicable that the image communication device be automatically set in the video mute-off state in telephone communication with an intimate person listed in an electronic phone book and the image communication device be automatically set in the video mute-on state in telephone communication with an unknown person not listed in the electronic phone book or a non-intimate person not admitted in the electronic phone book to be set to the video mute-off state. In this case, the electronic phone book 13 is additionally arranged in the image communication device. Also, in the same manner as in the fourth embodiment, it is applicable that the image communication device be automatically set in the video mute-on state, in cases where a ratio of an amount of erred data to an amount of data transmitted from the other end of telephone communication is high, and the image communication device be automatically set in the video mute-off state in cases where the ratio is low. In this case, the data error monitoring unit 14 is additionally arranged in the image communication device.

As is described above, in the fifth embodiment, video data stored in the video data storing unit 15 in advance is transmitted to the other end in cases where the image communication device is set in the video mute-on state. Therefore, in cases where the user desires not to transmit a picture photographing the user to the other end, another picture can be transmitted to the other end of the communication line. Accordingly, even though a picture photographing the user is not transmitted to the other end of the communication line, an unfavorable impression on the user made by a person on the other end of the communication line can be reduced.

In particular, in cases where a general picture other than a picture photographing the user is stored in advance in the video data storing unit 15, the general picture not received in the video data receiving unit 3 can be transmitted to the other end of the communication line. Also, it is applicable that video data of a favorite picture selected from various landscapes by the user be stored in advance in the video data storing unit 15 and be transmitted to the other end.

Also, it is applicable that compressed video data obtained by compressing video data of a picture be stored in advance in the video data storing unit 15. In this case, because a data volume of the compressed video data of a picture is lower than that received in the video data receiving unit 3, a data transmission time required for the transmission of the compressed video data can be shortened.

In the fifth embodiment, video data stored in the video data storing unit 15 is transmitted to the other end of the communication line when the image communication device is set in a video mute-on state. However it is applicable that no video data be transmitted to the other end of the communication line when the image communication device is set in a first type of video mute-on state and video data stored in the video data storing unit 15 be transmitted to the other end when the image communication device is set in a second type of video mute-on state.

Also, in the first to fifth embodiments, it is applicable that the features of the first to fifth embodiments be combined with each other. For example, in cases where the features of the first and second embodiments be combined with each other, the image communication device is automatically set to the video mute-on state at a time of the supply of an electric power to the image communication device and a predetermined time of day, and the image communication device is set to the video mute-off state in response to user's intention and another predetermined time of day. Therefore, the effects in the first to fifth embodiments can be obtained.

What is claimed is:

1. An image communication device comprising:
image receiving means for receiving an image;
image mute control means for automatically judging whether or not the image received by the image receiving means is output; and
image outputting means for outputting the image received by the image receiving means through a wire communication line or a radio communication line in cases where the image mute control means judges to output the image.

2. An image communication device according to claim 1, wherein the image mute control means controls the image outputting means not to output the image received by the image receiving means when a power is supplied to the image communication device, and the image mute control means controls the image outputting means according to a mute-off instruction to output the image received by the image receiving means.

3. An image communication device according to claim 1, further comprising:
time managing means for managing a passing time, wherein the image mute control means judges according to the passing time managed by the time managing means whether or not the image received by the image receiving means is output.

4. An image communication device according to claim 1, further comprising:
an electronic phone book for setting a mute-off state for each of other some ends of communication, wherein the image mute control means judges that the image received by the image receiving means is output to one end of communication in cases where the mute-off state is set for the end by the electronic phone book, and the image mute control means judges that the image received by the image receiving means is not output to one end of communication in cases where no mute-off state is set for the end by the electronic phone book.

5. An image communication device according to claim 1, further comprising:
error monitoring means for monitoring a degree of error occurring in the communication line, wherein the image mute control means judges according to the degree of error monitored by the error monitoring means whether or not the image received by the image receiving means is output.

6. An image communication device according to claim 1, further comprising:
image storing means for storing an image in advance, wherein the image stored by the image storing means is output by the image outputting means in cases where the image mute control means judges to output the image stored by the image storing means in place of the image received by the image receiving means.

7. An image communication method, comprising the steps of:
receiving an image;
automatically judging whether or not the received image is output; and
outputting the received image through a wire communication line or a radio communication line in cases where it is judged to output the received image.
